(19) United States
(12) Patent Application Publication
(10) Pub. No.: US 2025/0068173 A1
(43) Pub. Date: Feb. 27, 2025

(54) POINT CREATION METHOD AND APPARATUS, ELECTRONIC DEVICE, AND STORAGE MEDIUM

(71) Applicant: Beijing Youzhuju Network Technology Co., Ltd., Beijing (CN)

(72) Inventors: Qiusi WANG, Beijing (CN); Hongxiang SHU, Beijing (CN); Weizhi LIU, Beijing (CN)

(21) Appl. No.: 18/941,565

(22) Filed: Nov. 8, 2024

(30) Foreign Application Priority Data
Jan. 29, 2024 (CN) 202410123520.5

(51) Int. Cl. G05D 1/246; G05D 1/224; G05D 1/229; G05D 1/661; G05D 107/70

(52) U.S. Cl. CPC G05D 1/246; G05D 1/2246; G05D 1/229; G05D 1/661; G05D 2107/70

(57) ABSTRACT

Embodiments of the present disclosure provide a point creation method and apparatus, an electronic device, and a storage medium. The method includes: displaying an area map corresponding to a target area on a display interface in response to a first trigger operation; determining a point creation area in response to a trigger operation of a user for the area map; and creating a plurality of points automatically in the point creation area, and displaying the plurality of points on the area map, in response to a trigger operation for a batch creating of points.

### CROSS-REFERENCE TO RELATED APPLICATION

This application claims priority to Chinese Application No. 202410123520.5 filed in Jan. 29, 2024, the disclosure of which is incorporated herein by reference in its entity.

### FIELD

Embodiments of the present disclosure relate to robot application technologies, and in particular, to a point creation method and apparatus, an electronic device, and a storage medium.

### BACKGROUND

In a scenario where a task is performed based on a robot in a target area, for example, a warehousing scenario, there are usually a large number of task points that are densely distributed in the target area. Before the task is performed based on the robot, a task point needs to be created in an area map of the target area, so that the robot can go to the task point to perform the corresponding task.

In the related art, the robot is usually pushed to a site for on-site point creation, that is, the robot is pushed to a preset location on site, and then a point corresponding to the preset location is created in the map.

However, for point creation based on the above method, the point creation process is cumbersome, time-consuming, laborious, and inefficient. In addition, it may not be possible to meet the need to create points in a large area or across a plurality of maps.

### SUMMARY

Embodiments of the present disclosure provide a point creation method and apparatus, an electronic device, and a storage medium.

According to a first aspect, an embodiment of the present disclosure provides a point creation method. The method includes:
displaying an area map corresponding to a target area on a display interface in response to a first trigger operation;
determining a point creation area in response to a trigger operation of a user for the area map, where the point creation area corresponds to at least part of the target area; and
creating a plurality of points automatically in the point creation area, and displaying the plurality of points on the area map, in response to a trigger operation for a batch creating of points.

According to a second aspect, an embodiment of the present disclosure further provides a point creation apparatus. The apparatus includes:
a map display module configured to display an area map corresponding to a target area on a display interface in response to a first trigger operation;
an area determination module configured to determine a point creation area in response to a trigger operation of a user for the area map, where the point creation area corresponds to at least part of the target area; and
a point creation module configured to create a plurality of points automatically in the point creation area, and display the plurality of points on the area map, in response to a trigger operation for a batch creating of points.

According to a third aspect, an embodiment of the present disclosure further provides an electronic device. The electronic device includes:
one or more processors; and
a storage apparatus configured to store one or more programs, where
the one or more programs, when executed by the one or more processors, cause the one or more processors to implement the point creation method described in any one of the embodiments of the present disclosure.

According to a fourth aspect, an embodiment of the present disclosure further provides a storage medium containing computer-executable instructions, where the computer-executable instructions, when executed by a computer processor, are used to perform the point creation method described in any one of the embodiments of the present disclosure.

### BRIEF DESCRIPTION OF THE DRAWINGS

The foregoing and other features, advantages, and aspects of embodiments of the present disclosure become more apparent with reference to the following specific implementations and in conjunction with the accompanying drawings. Throughout the accompanying drawings, the same or similar reference numerals denote the same or similar elements. It should be understood that the accompanying drawings are schematic and that parts and elements are not necessarily drawn to scale.

FIG. 1 is a schematic flowchart of a point creation method according to an embodiment of the present disclosure;

FIG. 2 is a schematic flowchart of another point creation method according to an embodiment of the present disclosure;

FIG. 3 is a schematic flowchart of another point creation method according to an embodiment of the present disclosure;

FIG. 4 is a schematic flowchart of a point creation method according to an embodiment of the present disclosure;

FIG. 5 is a schematic diagram of a structure of a point creation apparatus according to an embodiment of the present disclosure; and

FIG. 6 is a schematic diagram of a structure of an electronic device according to an embodiment of the present disclosure.

### DETAILED DESCRIPTION OF EMBODIMENTS

The embodiments of the present disclosure are described in more detail below with reference to the accompanying drawings. Although some embodiments of the present disclosure are shown in the accompanying drawings, it should be understood that the present disclosure may be implemented in various forms and should not be construed as being limited to the embodiments set forth herein. Rather, these embodiments are provided for a more thorough and complete understanding of the present disclosure. It should be understood that the accompanying drawings and the embodiments of the present disclosure are only for exemplary purposes, and are not intended to limit the scope of protection of the present disclosure.

It should be understood that the various steps described in the method implementations of the present disclosure may be performed in different orders, and/or performed in parallel. Furthermore, additional steps may be included and/or the execution of the illustrated steps may be omitted in the method implementations. The scope of the present disclosure is not limited in this respect.

The term “include” used herein and the variations thereof are an open-ended inclusion, namely, “include but not limited to”. The term “based on” is “at least partially based on”. The term “an embodiment” means “at least one embodiment”. The term “another embodiment” means “at least one another embodiment”.

The term “some embodiments” means “at least some embodiments”. Related definitions of the other terms will be given in the description below.

It should be noted that concepts such as “first” and “second” mentioned in the present disclosure are only used to distinguish different apparatuses, modules, or units, and are not used to limit the sequence of functions performed by these apparatuses, modules, or units or interdependence.

It should be noted that the modifiers “one” and “a plurality of” mentioned in the present disclosure are illustrative and not restrictive, and those skilled in the art should understand that unless the context clearly indicates otherwise, the modifiers should be understood as “one or more”.

The names of messages or information exchanged between a plurality of apparatuses in the implementations of the present disclosure are used for illustrative purposes only, and are not used to limit the scope of these messages or information.

It can be understood that before the use of the technical solutions disclosed in the embodiments of the present disclosure, the user shall be informed of the type, range of use, use scenarios, etc., of personal information involved in the present disclosure in an appropriate manner in accordance with the relevant laws and regulations, and the authorization of the user shall be obtained.

For example, in response to reception of an active request from the user, prompt information is sent to the user to clearly inform the user that a requested operation will require access to and use of the personal information of the user. As such, the user can independently choose, based on the prompt information, whether to provide the personal information to software or hardware, such as an electronic device, an application, a server, or a storage medium, that performs operations in the technical solutions of the present disclosure.

As an optional but non-limiting implementation, in response to the reception of the active request from the user, the prompt information may be sent to the user in the form of, for example, a pop-up window, in which the prompt information may be presented in text. Furthermore, the pop-up window may also include a selection control for the user to choose whether to “agree” or “disagree” to provide the personal information to the electronic device.

It can be understood that the above process of notifying and obtaining the authorization of the user is only illustrative and does not constitute a limitation on the implementations of the present disclosure, and other manners that satisfy the relevant laws and regulations may also be applied in the implementations of the present disclosure.

It can be understood that the data involved in the technical solutions (including, but not limited to, the data itself and the access to or use of the data) shall comply with the requirements of corresponding laws, regulations, and relevant provisions.

Before the technical solutions are described, an exemplary description may be given to the application scenario. The technical solutions may be applied to any scenario in which it is required to create a point in a map. For case of description of the technical solutions provided in the embodiments of the present disclosure, the technical solutions provided in the embodiments of the present disclosure may be described by taking a warehousing scenario as an example. For example, in the warehousing scenario, a robot may be used to perform a delivery task. In general, before the robot is used to perform a task, a delivery task point needs to be created in an area map of a warehousing area, so that the robot can go to the task point to perform the corresponding task. In the related art, the robot is usually pushed to a site for on-site point creation, that is, the robot is pushed to a delivery point on site, and then a delivery task point corresponding to the delivery point is created in the map.

However, the warehousing area is large and includes many delivery points, and for point creation based on the above method, the point creation process is cumbersome, time-consuming, laborious, and inefficient. In addition, it may not be possible to meet the need to create points in a large area or across a plurality of maps.

In this case, based on the technical solutions of the embodiments of the present disclosure, an area map corresponding to a target area may be displayed on a display interface; further, a point creation area is determined in response to a trigger operation of a user for the area map; and thereafter, a plurality of points are automatically created in the point creation area and displayed on the area map, in response to a trigger operation for a batch creating of points. Thus, the technical problem of the map point location creation process being time-consuming, laborious, and inefficient in the related art is solved, and the effect of automatic batch creating of map point locations is achieved, thereby improving the efficiency of point location creation, and enhancing the convenience and efficiency of the point location creation process.

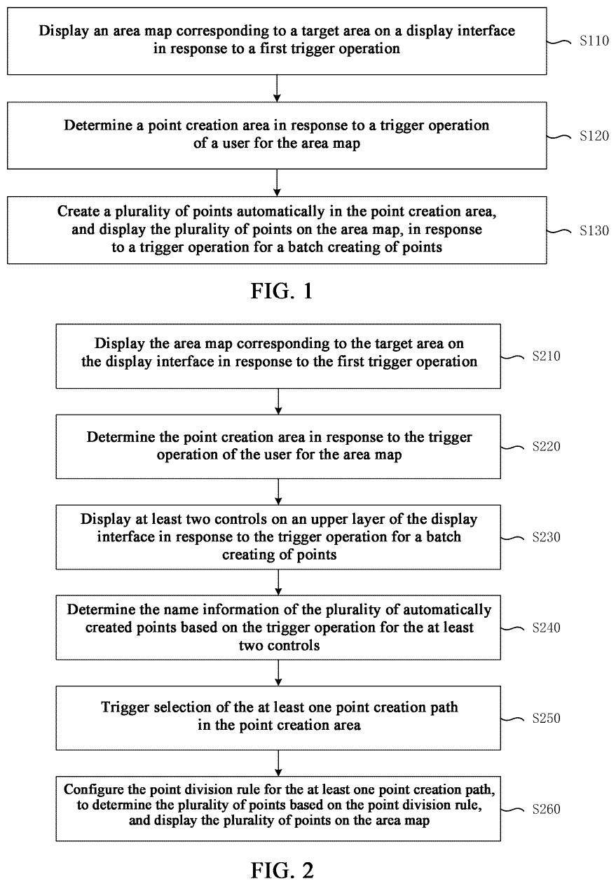

FIG. 1 is a schematic flowchart of a point creation method according to an embodiment of the present disclosure. This embodiment of the present disclosure is applicable to a case that a map point is created in an area map of a target area. The method may be performed by a point creation apparatus. The apparatus may be implemented in the form of software and/or hardware. Optionally, the apparatus may be implemented by an electronic device, which may be a mobile terminal, a PC, a server, or the like.

As shown in FIG. 1, the method of this embodiment may specifically include the following steps.
S110: Display an area map corresponding to a target area on a display interface in response to a first trigger operation.

In this embodiment, the first trigger operation may be understood as a map display trigger operation, that is, an operation that triggers display of the area map. Optionally, the first trigger operation may include at least one of the following: triggering a map display control; receiving an instruction associated with map display; and audio information including a wake-up word associated with map display, etc. For example, the map display control may be preset. Further, when it is detected that the control is triggered by the user, it can be determined that the first trigger operation is detected, and a response to the first trigger operation is made, i.e., displaying the area map corresponding to the target area on the display interface.

In this embodiment, the target area may be an area in which a point is to be created. The target area may be any area. For example, the target area may be a warehouse area. The area map may be understood as data representing spatial distribution of the target area. For example, if the target area is the warehouse area, the area map is a warehouse map.

In practical application, when the trigger operation for map display is detected, it can be determined that the first trigger operation is detected. Further, the response to the first trigger operation is made, and a target area corresponding to the first trigger operation is determined. Thereafter, the area map corresponding to the target area may be retrieved based on the target area, and the retrieved area map is displayed on the display interface.

It should be noted that there may be a plurality of implementations of retrieving the area map corresponding to the target area. Optionally; the retrieval of the area map corresponding to the target area includes: obtaining an area identifier of the target area; and determining and retrieving the area map corresponding to the target area based on the area identifier and predetermined identifier-map association information.

The identifier-map association information is used to indicate an association relationship between the area identifier and the area map.

In practical application, a plurality of areas in which a point is to be created may be predetermined, and an area map corresponding to each area may be constructed. Thereafter, an area identifier of each area may be obtained, and the area identifier may be stored in association with a corresponding area map, to obtain the identifier-map association information. Further, when the target area is determined based on the first trigger operation, the area identifier of the target area may be obtained. Then, the area map of the target area may be determined and retrieved based on the area identifier and the identifier-map association information. Then, the retrieved area map may be displayed on the display interface.
S120: Determine a point creation area in response to a trigger operation of a user for the area map.

In this embodiment, the trigger operation for the area map may be understood as a selection trigger operation for at least part of the area in the area map. The trigger operation may be any operation performed on the area map. Optionally; the trigger operation for the area map may be a click operation for the area map. The click operation may be a single-click operation or a multi-click operation (e.g., a double-click operation, etc.). For operational convenience for the user, the trigger operation for the area map may also be that when it is detected that the user holds on any area on the area map for a preset time based on an input device or a touch point, the operation may be seen as the trigger operation for the area map. The point creation area corresponds to at least part of the target area. The point creation area may be understood as the at least part of the target area, and the part of the area is the area in which the point is to be created. The point may be understood as a location of an object located in space or a specific location of a place. In this embodiment, the point may be a point at which a robot is placed, that is, a point that the robot is to reach. Different scenarios correspond to different points. For example, in the warehousing scenario, the target area is the warehouse area, and a created point may be a delivery point.

In practical application, at least part of the target area may be the area in which the point is to be created. After the area map corresponding to the target area is displayed on the display interface, a trigger operation may be input for a map that corresponds to the point creation area in the area map according to a predetermined point creation requirement, an area corresponding to the trigger operation may be determined, and the area may be used as the point creation area.
S130: Create a plurality of points automatically in the point creation area, and display the plurality of points on the area map, in response to a trigger operation for a batch creating of points.

In this embodiment, the trigger operation for a batch creating of points may be understood as an operation that triggers creation of a plurality of points, that is, an operation that allows simultaneous creation of a plurality of points with a single trigger. Optionally, the trigger operation for a batch creating of points may include at least one of the following: triggering a batch creating of points control; receiving a batch creating of points instruction; and audio information including a keyword associated with a batch creating of points, etc. For example, the batch creating of points control may be preset and displayed on the display interface. Further, when a trigger operation for the control is detected, a response to the trigger operation may be made, and a plurality of points may be automatically created in the point creation area.

The point may be understood as a location at which the robot is placed in the target area, or a location at which the robot performs a corresponding task in the target area. For example, if the target area corresponding to the point creation area is the warehouse area, the point may be the delivery point, that is, a location that the robot needs to go to when performing a delivery task.

In practical application, when the trigger operation for a batch creating of points is detected, the response to the trigger operation may be made, and then, the plurality of points may be created in the point creation area, and the created points may be displayed on the area map.

It should be noted that the created point may be the point at which the robot is placed, or may be a point that the robot passes through when performing a task. Generally, a robot performs a corresponding task according to a preset task performing path. Therefore, in order to quickly determine the plurality of points in the point creation area so as to achieve the effect of automatic a batch creating of points, at least one point creation path may be determined in the point creation area in response to the trigger operation for a batch creating of points. Then, for each point creation path, a start point and an end point in a current point creation path may be determined, and the start point and the end point are used as the created points. Then, point division may be performed on the current point creation path based on a predetermined point division rule, to obtain a plurality of points associated with the current point creation path. Then, the plurality of points associated with the point creation area may be obtained, and the plurality of created points may be displayed on the area map.

It should also be noted that in order to facilitate the management of the created points, after the responding to the trigger operation for a batch creating of points, point attribute information of the plurality of automatically created points may further be determined. Then, the point attribute information may be associated with the plurality of automatically created points, and the plurality of points and the corresponding point attribute information may be displayed on the area map. The point attribute information may be any attribute information associated with the point. Optionally, the point attribute information may be a point name.

It should be noted that in addition to the plurality of automatically created points and the corresponding point attribute information, the area map for which point creation has been completed may further display robot information corresponding to a robot that is associated with the target area. The displayed robot may be a robot that is currently performing a task in the target area. The robot information may include a robot identifier, robot motion orientation information, and/or robot docking orientation information, etc. In addition, in order to browse the distribution of the points and the motion of robot more clearly and intuitively, the points and the robot may be displayed on the area map distinguishably.

According to the technical solution of this embodiment of the present disclosure, the area map corresponding to the target area is displayed on the display interface in response to the first trigger operation; further, the point creation area is determined in response to the trigger operation of the user for the area map; and finally, the plurality of points are automatically created in the point creation area and displayed on the area map, in response to the trigger operation for a batch creating of points. Thus, the technical problem of the map point creation process being time-consuming, laborious, and inefficient in the related art is solved, and the effect of automatic batch creating of map points is achieved, thereby improving the efficiency of point creation, and enhancing the convenience and efficiency of the point creation process.

FIG. 2 is a schematic flowchart of another point creation method according to an embodiment of the present disclosure. On the basis of the above embodiment and according to the technical solution of this embodiment, name information of the plurality of automatically created points may also be determined. For a specific implementation, reference may be made to description of this embodiment. Details about technical features that are the same as or similar to those in the above embodiment are not described herein again.

As shown in FIG. 2, the method of this embodiment may specifically include the following steps.
S210: Display the area map corresponding to the target area on the display interface in response to the first trigger operation.
S220: Determine the point creation area in response to the trigger operation of the user for the area map.
S230: Display at least two controls on an upper layer of the display interface in response to the trigger operation for a batch creating of points.

In this embodiment, the upper layer of the display interface may be understood as a layer overlying a layer where the display interface is located, that is, the layer above the layer where the display interface is located. The at least two controls may be displayed on the upper layer of the display interface. The at least two controls may correspond to an automatic point name import control and a rule-based point name generation control. The automatic point name import control may be a control for automatically importing a predetermined point name and applying the imported point name. The rule-based point name generation control may be a control that generates a point name based on a predetermined name generation rule.

In practical application, when the trigger operation for a batch creating of points is detected, the response to the trigger operation may be made. Further, in order to make the information of the created points that is displayed on the area map richer, and to facilitate the management of the created points, a point name editing page including the at least two controls may be displayed, and the page may be displayed on the upper layer of the display interface. Then, the name information of each of the automatically created points may be determined based on a trigger operation of the user for the displayed controls and based on a name determination logic corresponding to the triggered controls.

It should be noted that, in addition to the automatic point name import control and the rule-based point name generation control, the upper layer of the display interface may also display other preset controls, which is not specifically limited in this embodiment of the present disclosure.
S240: Determine the name information of the plurality of automatically created points based on the trigger operation for the at least two controls.

In this embodiment, the trigger operation for the at least two controls may be any operation performed on the two controls. Optionally, the trigger operation for the at least two controls may be a click operation (such as a single-click operation or a double-click operation) for the control; alternatively, the trigger operation for the at least two controls may also be that when it is detected that the user holds on the at least two controls for a preset time based on the input device or the touch point, the operation may be used as the trigger operation for the at least two controls. The name information may be understood as an identifier used to identify the point.

In practical application, when the at least two controls are displayed on the upper layer of the display interface, a trigger operation may be input for the displayed control. Further, when a trigger operation for any control is detected, a response to the trigger operation may be made, and the name information of the plurality of automatically created points may be determined based on a name determination manner corresponding to the triggered control. It should be noted that the at least two controls correspond to the automatic point name import control and the rule-based point name generation control, and when being triggered, the automatic point name import control and the rule-based point name generation control correspond to different name information determination manners. The name information determination manners corresponding to the two controls may be respectively described below.

Optionally, if the automatic point name import control is triggered, a target document that includes a plurality of point names to be used is imported, to determine name information corresponding to the plurality of created points based on the point names to be used in the target document.

In this embodiment, the point names to be used may be predetermined point names that are to be used. The target document may be understood as a document that is used to store point attribute information associated with the points (such as the point names). The target document may be a document in any format. Optionally, the target document may be a document in spreadsheet (Excel) format. It should be noted that a number of target documents may be consistent with a number of point creation areas, or the number of the target documents may be one, that is, a plurality of point creation areas correspond to one target document.

In practical application, a plurality of point names may be generated in advance based on a point name generation rule, and the generated point names may be used as the point names to be used. Further, a plurality of points names to be used may be stored in a document in a preset format based on a predetermined name storage rule, to obtain the target document including the plurality of point names to be used, and the target document may be stored in a target terminal.

Further, when a trigger operation for the automatic point name import control is detected, a response to the trigger operation may be made. Then, a target document to be imported is determined, and the target document including the plurality of point names to be used is imported. Thereafter, a point name to be used that corresponds to each point may be determined based on an arrangement logic of the plurality of point names to be used in the target document and a distribution logic of the plurality of created points. Then, the point name to be used that corresponds to each point may be used as name information corresponding to the point, that is, point information corresponding to the plurality of created points may be obtained. An advantage of such setup is that: the effect of determining the name information of the created points based on the pre-created point name document is achieved, and further, the point name determination efficiency is improved.

Optionally, if the rule-based point name generation control is triggered, a point auto-increment rule editing page is displayed; and the name information of the plurality of points is determined based on a point name generation rule in the point auto-increment rule editing page.

In this embodiment, the point auto-increment rule editing page may be understood as a visual page for point editing. The point auto-increment rule editing page may include a plurality of rules associated with a point editing process. Optionally, the point auto-increment rule editing page may include the point name generation rule and a point spacing setting rule. The point name generation rule may be understood as a rule based on which the point names are determined. It should be noted that the point auto-increment rule editing page may include at least one rule configuration item associated with the point name generation rule. Optionally, the at least one rule configuration item may include an area at which the point is located, a task type corresponding to the point, and/or a path on which the point is located.

In practical application, when a trigger operation for the rule-based point name generation control is detected, a response to the trigger operation may be made, and the point auto-increment rule editing page may be displayed, where the editing page may include the at least one rule configuration item associated with the name generation rule. Further, the user may configure the at least one rule configuration item that is displayed. Thereafter, when a configuration completion operation is detected, a rule configured in the page may be obtained, and the point name generation rule may be determined based on the obtained rule. Then, the name information corresponding to the plurality of created points may be determined based on the point name generation rule. An advantage of such setup is that: the effect of generating the point names in real time based on the point generation rule is achieved, the flexibility of a point name determination process is enhanced, and the effect of custom editing of the point names is achieved.

It should be noted that in addition to the two point name determination manners described above, the point name may also be set manually, that is, the name information of the points is customized by the user.

It should also be noted that in order to facilitate the management of the points displayed on the map, and in order to browse the points and their corresponding names more clearly and intuitively, in the process of creating the plurality of points automatically in the point creation area, the method further includes: associating the name information with the plurality of automatically created points, and displaying the plurality of points and the corresponding name information on the area map.

In practical application, after the name information corresponding to the plurality of points is determined, for each point, name information corresponding to a current point may be associated with the current point. Further, the current point and the name information corresponding to the current point may be displayed on the area map.
S250: Trigger selection of the at least one point creation path in the point creation area.

The point creation path includes a start point and an end point. In this embodiment, the point creation path may be understood as a path based on which the points are created, or the point creation path may be a path constructed from the plurality of points. The start point may be a point creation start point on the path. The end point may be a point creation end point on the path. It should be noted that the point creation path may be associated with a task performing path for the robot.

In practical application, after the point creation area is determined, selection of at least one start point and an end point corresponding to each start point may be triggered on an area map corresponding to the point creation area. Then, for each start point, one path may be generated based on a current start point and an end point corresponding to the start point, and the path may be used as a point creation path including the current start point and the corresponding end point. Then, the at least one point creation path may be obtained. It should be noted that for each point creation path, a start point and an end point in a current point creation path may be used as two points associated with the current point creation path, and the two points may be displayed on the area map.
S260: Configure the point division rule for the at least one point creation path, to determine the plurality of points based on the point division rule, and display the plurality of points on the area map.

In this embodiment, the point division rule may be understood as a rule based on which the points are divided. It should be noted that at least one rule configuration item for configuring the point division rule may be included. Optionally, the at least one rule configuration item may include point spacing and/or point distribution, etc.

In practical application, in order to perform point division on the at least one determined point creation path, the point auto-increment rule editing page may be displayed after the at least one point creation path is determined, where the editing page may include the at least one rule configuration item associated with the point division rule. Further, for each point creation path, the at least one rule configuration item displayed on the editing page may be configured. Then, when a trigger operation for configuration completion is detected, information configured in the editing page may be obtained, and a point division rule corresponding to the current point creation path may be determined based on the obtained information. Then, a point division rule corresponding to each point creation path may be obtained. Further, point division may be performed on a corresponding point creation path based on the point division rule. Then, the plurality of points may be obtained and displayed on the area map.

It should be noted that the determined point is the point at which the robot is placed, i.e., a docking point of the robot. In the process of the robot performing a task, a docking location of the robot may directly determine the efficiency in performing the task. Therefore, in order to improve task performing efficiency of the robot at each point, orientation information may also be configured for the plurality of points, so that the robot docks based on the orientation information.

In this embodiment, the orientation information may be understood as a direction that the robot faces.

In practical application, orientation information may also be configured for each point after the plurality of points are determined. Further, when the robot reaches any point, the robot may be made to dock based on orientation information of the point.

According to the technical solution of this embodiment of the present disclosure, the area map corresponding to the target area is displayed on the display interface in response to the first trigger operation; then, the point creation area is determined in response to the trigger operation of the user for the area map; then, the at least two controls are displayed on the upper layer of the display interface in response to the trigger operation for a batch creating of points; thereafter, the name information of the plurality of automatically created points are determined based on the trigger operation for the at least two controls; thereafter, the selection of the at least one point creation path is trigged in the point creation area; and finally, the point division rule is configured for the at least one point creation path, so as to determine the plurality of points based on the point division rule and display the plurality of points on the area map. In this way, the effect of simultaneously determining the name information of the plurality of points is achieved, and further, the point editing efficiency is improved, and the convenience and efficiency of point creation are improved.

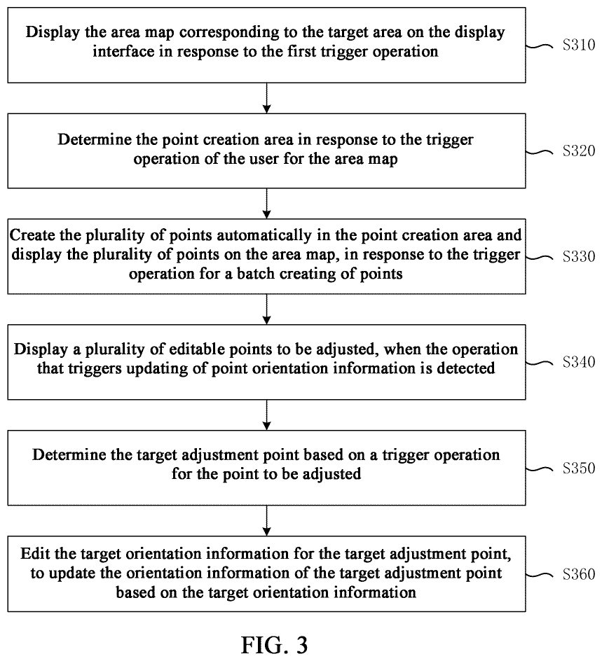

FIG. 3 is a schematic flowchart of another point creation method according to an embodiment of the present disclosure. On the basis of the above embodiment and according to the technical solution of this embodiment, a target adjustment point is determined when an operation that triggers updating of point orientation information is detected, and then, target orientation information is edited for the target adjustment point, to update orientation information of the target adjustment point based on the target orientation information. For a specific implementation, reference may be made to description of this embodiment. Details about technical features that are the same as or similar to those in the above embodiment are not described herein again.

As shown in FIG. 3, the method of this embodiment may specifically include the following steps.
S310: Display the area map corresponding to the target area on the display interface in response to the first trigger operation.
S320: Determine the point creation area in response to the trigger operation of the user for the area map.
S330: Create the plurality of points automatically in the point creation area, and display the plurality of points on the area map, in response to the trigger operation for a batch creating of points.
S340: Display a plurality of editable points to be adjusted, when the operation that triggers updating of point orientation information is detected.

In this embodiment, the operation that triggers updating of point orientation information may be any trigger operation that allows for updating of point orientation information. Optionally, the operation that triggers updating of point orientation information may include at least one of the following: triggering a point orientation information updating control; receiving a point orientation information updating instruction; and audio information including a wake-up word associated with updating of point orientation information, etc. The point to be adjusted may be understood as a point whose orientation information is to be adjusted. The displayed editable point to be adjusted may be any point among the plurality of points that have been created. Optionally, the point to be adjusted includes at least one of the following:
First: all points in the target area.

In this embodiment, when the operation that triggers updating of point orientation information is detected, all points in the target area may be used as the editable points to be adjusted, and the points to be adjusted may be displayed.
Second: points created in the same batch as a point to be adjusted that triggers selection.

In practical application, when the trigger operation that triggers updating of point orientation information is detected, the user may input a selection trigger operation for the points in the target area. When a selection trigger operation for any point is detected, the point may be used as the point to be adjusted that triggers selection. Then, point creation information corresponding to the point to be adjusted may be obtained, and the points created in the same batch as the point to be adjusted may be determined in the target area based on the point creation information. Then, the determined points and the point to be adjusted that triggers selection may be used as the editable points to be adjusted, which are then displayed.
Third: points located in the same direction as the point to be adjusted that triggers selection.

In practical application, when the selection trigger operation for any point is detected, the point may be used as the point to be adjusted that triggers selection. Then, a point orientation corresponding to the point to be adjusted may be determined. Then, a point that has an orientation consistent with the orientation of the point may be determined from the plurality of points created in the target area. Then, the determined points and the point to be adjusted that triggers selection may be used as the editable points to be adjusted, which are then displayed.

It should be noted that when the operation that triggers updating of point orientation information is detected, in order to facilitate the updating of the orientation information of the point whose orientation information is to be updated, only the plurality of editable points to be adjusted may be displayed, and other points in the target area may not be displayed.
S350: Determine the target adjustment point based on a trigger operation for the point to be adjusted.

In this embodiment, when the plurality of editable points to be adjusted are displayed, the user may select a point to be adjusted from the plurality of displayed points to be adjusted through a trigger operation. Then, when the trigger operation for any point to be adjusted is detected, the point to be adjusted may be used as the target adjustment point. Optionally, the trigger operation for the point to be adjusted may include at least one of the following: a click operation for the point to be adjusted, such as a single-click operation or a double-click operation; and holding on the point to be adjusted for a preset time, etc.
S360: Edit the target orientation information for the target adjustment point, to update the orientation information of the target adjustment point based on the target orientation information.

In this embodiment, the editing the target orientation information for the target adjustment point may be an orientation information editing input operation, that is, inputting updated orientation information into a page for orientation information editing, obtaining the input information when an editing completion trigger operation is detected, and using the input information as the target orientation information; alternatively, the editing the target orientation information for the target adjustment point may also be a trigger operation for the point, that is, the target adjustment point may be triggered by an input device or a touch point, and a trigger selection state may be maintained. Then, the target adjustment point may be rotated in the area map by the input device or the touch point. Further, when it is detected that the target adjustment point is not in the trigger selection state, in this case, the orientation information of the target adjustment point may be determined, and the orientation information may be used as the target orientation information.

In practical application, after the target adjustment point is determined, the orientation information of the target adjustment point may be edited to obtain the target orientation information. Further, the orientation information of the target adjustment point may be updated based on the target orientation information. Then, when the robot reaches the target adjustment point, the robot may be made to dock based on the updated orientation information.

According to the technical solution of this embodiment of the present disclosure, the area map corresponding to the target area is displayed on the display interface in response to the first trigger operation; further, the point creation area is determined in response to the trigger operation of the user for the area map, and then, the plurality of points are created automatically in the point creation area and displayed on the area map, in response to the trigger operation for a batch creating of points; further, when the operation that triggers updating of point orientation information is detected, the plurality of editable points to be adjusted are displayed, and thereafter, the target adjustment point is determined based on the trigger operation for the point to be adjusted, and the target orientation information is edited for the target adjustment point, so that the orientation information of the target adjustment point is updated based on the target orientation information. Thus, the effect of dynamically adjusting the point orientation information is achieved, thereby enhancing the scalability and flexibility of the point creation process.

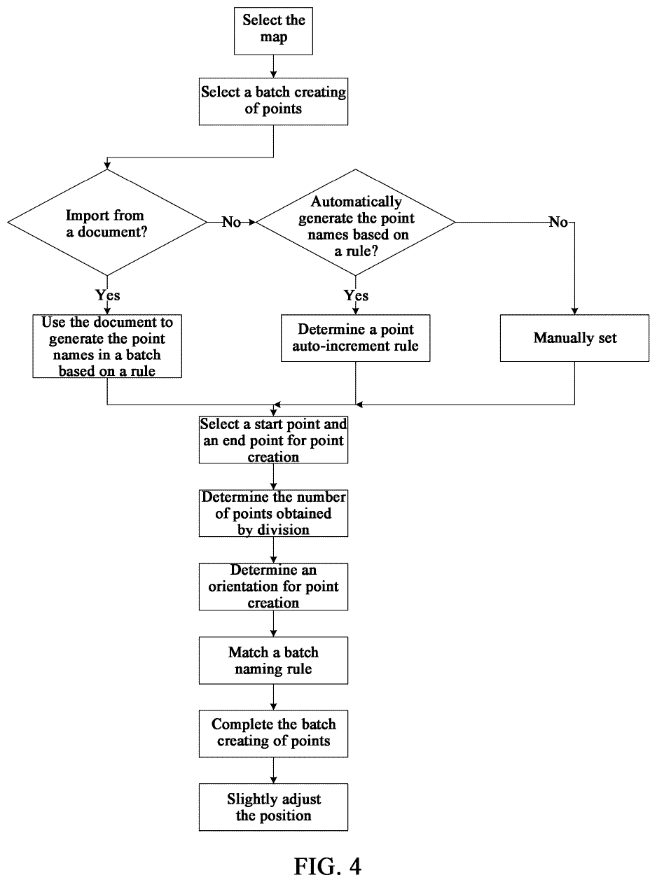

FIG. 4 is a schematic flowchart of a point creation method according to an embodiment of the present disclosure. This embodiment of the present disclosure is an optional embodiment of each of the above embodiments. As shown in FIG. 4, the method in this embodiment of the present disclosure may include the following steps.

First, the area map is displayed on the display interface. Then, it is determined whether to import from a target document including a plurality of point names in response to the trigger operation for a batch creating of points. If it is determined to import the target document, the target document is used to generate the point names based on a rule; and if it is determined not to import the target document, it is determined whether to automatically generate the point names based on a rule. If it is determined to automatically generate the point names, a point auto-increment rule is determined, and the point names are generated based on the point auto-increment rule; and if it is determined not to automatically generate the point names, the point names are manually set. Then, selection of a start point and an end point for point creation is triggered based on the area map. Then, the number of points obtained by division is determined. Then, orientation information is configured for each point. Then, a batch naming rule may be matched for each point. Then, the batch creating of points may be completed. Further, after the point creation is completed, a corresponding relationship between the points and a warehouse location is established so that it is possible to make dynamic adjustment when the points or the warehouse location changes.

According to the technical solution of this embodiment of the present disclosure, the area map corresponding to the target area is displayed on the display interface in response to the first trigger operation; further, the point creation area is determined in response to the trigger operation of the user for the area map; and finally, the plurality of points are automatically created in the point creation area and displayed on the area map, in response to the trigger operation for a batch creating of points. Thus, the technical problem of the map point creation process being time-consuming, laborious, and inefficient in the related art is solved, and the effect of automatic batch creating of map points is achieved, thereby improving the efficiency of point creation, and enhancing the convenience and efficiency of the point creation process.

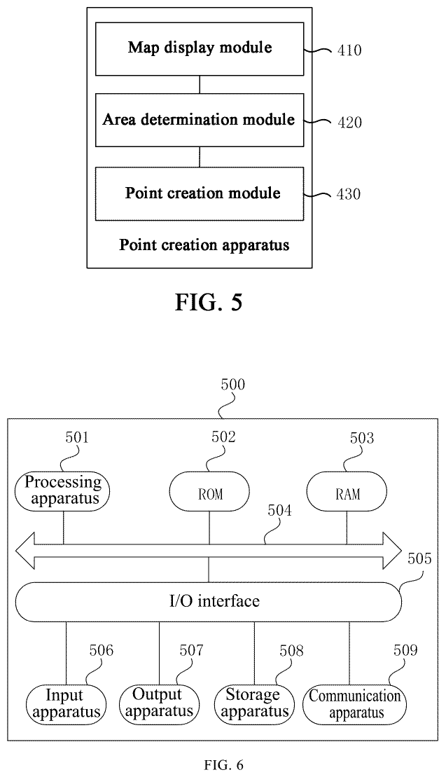

FIG. 5 is a schematic diagram of a structure of a point creation apparatus according to an embodiment of the present disclosure. As shown in FIG. 5, the apparatus includes: a map display module 410, an area determination module 420, and a point creation module 430.
where the map display module 410 is configured to display an area map corresponding to a target area on a display interface in response to a first trigger operation; the area determination module 420 is configured to determine a point creation area in response to a trigger operation of a user for the area map, where the point creation area corresponds to at least part of the target area; and the point creation module 430 is configured to create a plurality of points automatically in the point creation area, and display the plurality of points on the area map, in response to a trigger operation for a batch creating of points.

On the basis of the above optional technical solutions, optionally, the apparatus further includes: a control display module and a name determination module,
where the control display module is configured to display at least two controls on an upper layer of the display interface after the responding to a trigger operation for a batch creating of points, where the at least two controls correspond to an automatic point name import control and a rule-based point name generation control; and
the name determination module is configured to determine name information of the plurality of automatically created points based on a trigger operation for the at least two controls.

On the basis of the above optional technical solutions, optionally; the name determination module includes: a document import unit,
where the document import unit is configured to, if the automatic point name import control is triggered, import a target document that includes a plurality of point names to be used, to determine name information corresponding to the plurality of created points based on the point names to be used in the target document.

On the basis of the above optional technical solutions, optionally; the name determination module includes: a page display unit and a name determination unit,
where the page display unit is configured to, if the rule-based point name generation control is triggered, display a point auto-increment rule editing page; and
the name determination unit is configured to determine the name information of the plurality of points based on a point name generation rule in the point auto-increment rule editing page.

On the basis of the above optional technical solutions, optionally, the point creation module 430 includes: a path selection unit and a point determination unit,
where the path selection unit is configured to trigger selection of at least one point creation path in the point creation area after the name information of the plurality of automatically created points is determined, where the point creation path includes a start point and an end point; and
the point determination unit is configured to configure a point division rule for the at least one point creation path, to determine the plurality of points based on the point division rule.

On the basis of the above optional technical solutions, optionally, the apparatus further includes: an orientation configuration module,
where the orientation configuration module is configured to configure orientation information for the plurality of points, so that the robot docks based on the orientation information.

On the basis of the above optional technical solutions, optionally, the apparatus further includes: a point association module,
where the point association module is configured to associate the name information with the plurality of automatically created points, and display the plurality of points and the corresponding name information on the area map, in the process of creating the plurality of points automatically in the point creation area.

On the basis of the above optional technical solutions, optionally, the apparatus further includes: a point display module, a point determination module, and an orientation information editing module.
where the point display module is configured to display a plurality of editable points to be adjusted, when an operation that triggers updating of point orientation information is detected;
the point determination module is configured to determine a target adjustment point based on a trigger operation for the point to be adjusted; and
the orientation information editing module is configured to edit target orientation information for the target adjustment point, to update orientation information of the target adjustment point based on the target orientation information.

On the basis of the above optional technical solutions, optionally, the point to be adjusted includes at least one of the following: all points in the target area; points created in the same batch as a point to be adjusted that triggers selection; and points located in the same direction as the point to be adjusted that triggers selection.

According to the technical solution of this embodiment of the present disclosure, the area map corresponding to the target area is displayed on the display interface in response to the first trigger operation; further, the point creation area is determined in response to the trigger operation of the user for the area map; and finally, the plurality of points are automatically created in the point creation area and displayed on the area map, in response to the trigger operation for a batch creating of points. Thus, the technical problem of the map point creation process being time-consuming, laborious, and inefficient in the related art is solved, and the effect of automatic batch creating of map points is achieved, thereby improving the efficiency of point creation, and enhancing the convenience and efficiency of the point creation process.

The point creation apparatus according to this embodiment of the present disclosure can perform the point creation method according to any one of the embodiments of the present disclosure, and has corresponding functional modules and beneficial effects for performing the method.

It is worth noting that the units and modules included in the above apparatus are obtained through division merely according to functional logic, but are not limited to the above division, as long as corresponding functions can be implemented. In addition, specific names of the functional units are merely used for mutual distinguishing, and are not used to limit the protection scope of the embodiments of the present disclosure.

FIG. 6 is a schematic diagram of a structure of an electronic device according to an embodiment of the present disclosure. Reference is made to FIG. 6 below, which is a schematic diagram of a structure of an electronic device (such as a terminal device or a server in FIG. 6) 500 suitable for implementing embodiments of the present disclosure. The terminal device in this embodiment of the present disclosure may include, but is not limited to, mobile terminals such as a mobile phone, a notebook computer, a digital broadcast receiver, a personal digital assistant (PDA), a PAD (tablet computer), a portable multimedia player (PMP), and a vehicle-mounted terminal (such as a vehicle navigation terminal), and fixed terminals such as a digital TV and a desktop computer. The electronic device shown in FIG. 6 is merely an example, and shall not impose any limitation on the function and scope of use of the embodiments of the present disclosure.

As shown in FIG. 6, the electronic device 500 may include a processing apparatus (e.g., a central processing unit or a graphics processing unit) 501 that may perform a variety of appropriate actions and processing in accordance with a program stored in a read-only memory (ROM) 502 or a program loaded from a storage apparatus 508 into a random access memory (RAM) 503. The RAM 503 further stores various programs and data required for the operation of the electronic device 500. The processing apparatus 501, the ROM 502, and the RAM 503 are connected to each other through a bus 504. An input/output (I/O) interface 505 is also connected to the bus 504.

Generally, the following apparatuses may be connected to the I/O interface 505: an input apparatus 506 including, for example, a touchscreen, a touchpad, a keyboard, a mouse, a camera, a microphone, an accelerometer, and a gyroscope; an output apparatus 507 including, for example, a liquid crystal display (LCD), a speaker, and a vibrator; the storage apparatus 508 including, for example, a tape and a hard disk; and a communication apparatus 509. The communication apparatus 509 may allow the electronic device 500 to perform wireless or wired communication with other devices to exchange data. Although FIG. 6 shows the electronic device 500 having various apparatuses, it should be understood that it is not required to implement or have all of the shown apparatuses. It may be an alternative to implement or have more or fewer apparatuses.

In particular, according to an embodiment of the present disclosure, the process described above with reference to the flowchart may be implemented as a computer software program. For example, this embodiment of the present disclosure includes a computer program product, which includes a computer program carried on a non-transitory computer-readable medium, where the computer program includes program code for performing the method shown in the flowchart. In such an embodiment, the computer program may be downloaded from a network through the communication apparatus 509 and installed, installed from the storage apparatus 508, or installed from the ROM 502. When the computer program is executed by the processing apparatus 501, the above-mentioned functions defined in the method of the embodiment of the present disclosure are performed.

The names of messages or information exchanged between a plurality of apparatuses in the implementations of the present disclosure are used for illustrative purposes only, and are not used to limit the scope of these messages or information.

The electronic device according to this embodiment of the present disclosure and the point creation method according to the above embodiments belong to the same inventive concept. For the technical details not exhaustively described in this embodiment, reference may be made to the above embodiments, and this embodiment and the above embodiments have the same beneficial effects.

An embodiment of the present disclosure provides a computer storage medium storing a computer program thereon, where the program, when executed by a processor, implements the point creation method according to the above embodiments.

It should be noted that the above computer-readable medium described in the present disclosure may be a computer-readable signal medium, a computer-readable storage medium, or any combination thereof. The computer-readable storage medium may be, for example but not limited to, electric, magnetic, optical, electromagnetic, infrared, or semiconductor systems, apparatuses, or devices, or any combination thereof. A more specific example of the computer-readable storage medium may include, but is not limited to: an electrical connection having one or more wires, a portable computer magnetic disk, a hard disk, a random access memory (RAM), a read-only memory (ROM), an erasable programmable read-only memory (EPROM) (or a flash memory), an optical fiber, a portable compact disc read-only memory (CD-ROM), an optical storage device, a magnetic storage device, or any suitable combination thereof. In the present disclosure, the computer-readable storage medium may be any tangible medium containing or storing a program which may be used by or in combination with an instruction execution system, apparatus, or device. In the present disclosure, the computer-readable signal medium may include a data signal propagated in a baseband or as a part of a carrier, the data signal carrying computer-readable program code. The propagated data signal may be in various forms, including but not limited to an electromagnetic signal, an optical signal, or any suitable combination thereof. The computer-readable signal medium may also be any computer-readable medium other than the computer-readable storage medium. The computer-readable signal medium can send, propagate, or transmit a program used by or in combination with an instruction execution system, apparatus, or device. The program code contained in the computer-readable medium may be transmitted by any suitable medium, including but not limited to: electric wires, optical cables, radio frequency (RF), etc., or any suitable combination thereof.

In some implementations, the client and the server may communicate using any currently known or future-developed network protocol such as a Hypertext Transfer Protocol (HTTP), and may be connected to digital data communication (for example, communication network) in any form or medium. Examples of the communication network include a local area network (“LAN”), a wide area network (“WAN”), an internetwork (for example, the Internet), a peer-to-peer network (for example, an ad hoc peer-to-peer network), and any currently known or future-developed network.

The above computer-readable medium may be contained in the above electronic device. Alternatively, the computer-readable medium may exist independently, without being assembled into the electronic device.

The above computer-readable medium carries one or more programs that, when executed by the electronic device, cause the electronic device to: display an area map corresponding to a target area on a display interface in response to a first trigger operation; determine a point creation area in response to a trigger operation of a user for the area map, where the point creation area corresponds to at least part of the target area; and create a plurality of points automatically in the point creation area, and display the plurality of points on the area map, in response to a trigger operation for a batch creating of points.

Computer program code for performing operations of the present disclosure can be written in one or more programming languages or a combination thereof, where the programming languages include but are not limited to object-oriented programming languages, such as Java, Smalltalk, and C++, and further include conventional procedural programming languages, such as “C” language or similar programming languages. The program code may be completely executed on a computer of a user, partially executed on a computer of a user, executed as an independent software package, partially executed on a computer of a user and partially executed on a remote computer, or completely executed on a remote computer or server. In the case of the remote computer, the remote computer may be connected to the computer of the user through any kind of network, including a local area network (LAN) or a wide area network (WAN), or may be connected to an external computer (for example, connected through the Internet with the aid of an Internet service provider).

The flowchart and block diagram in the accompanying drawings illustrate the possibly implemented architecture, functions, and operations of the system, method, and computer program product according to various embodiments of the present disclosure. In this regard, each block in the flowchart or block diagram may represent a module, program segment, or part of code, and the module, program segment, or part of code contains one or more executable instructions for implementing the specified logical functions. It should also be noted that, in some alternative implementations, the functions marked in the blocks may also occur in an order different from that marked in the accompanying drawings. For example, two blocks shown in succession can actually be performed substantially in parallel, or they can sometimes be performed in the reverse order, depending on the functions involved. It should also be noted that each block in the block diagram and/or the flowchart, and a combination of the blocks in the block diagram and/or the flowchart may be implemented by a dedicated hardware-based system that executes specified functions or operations, or may be implemented by a combination of dedicated hardware and computer instructions.

The related units described in the embodiments of the present disclosure may be implemented by software, or may be implemented by hardware. Names of the units do not constitute a limitation on the units themselves in some cases, for example, a first obtaining unit may alternatively be described as “a unit for obtaining at least two Internet Protocol addresses”.

The functions described herein above may be performed at least partially by one or more hardware logic components. For example, without limitation, exemplary types of hardware logic components that may be used include: a field programmable gate array (FPGA), an application-specific integrated circuit (ASIC), an application-specific standard product (ASSP), a system-on-chip (SOC), a complex programmable logic device (CPLD), and the like.

In the context of the present disclosure, a machine-readable medium may be a tangible medium that may contain or store a program used by or in combination with an instruction execution system, apparatus, or device. The machine-readable medium may be a machine-readable signal medium or a machine-readable storage medium. The machine-readable medium may include, but is not limited to, an electronic, magnetic, optical, electromagnetic, infrared, or semiconductor system, apparatus, or device, or any suitable combination thereof. More specific examples of the machine-readable storage medium may include an electrical connection based on one or more wires, a portable computer disk, a hard disk, a random access memory (RAM), a read-only memory (ROM), an erasable programmable read-only memory (EPROM) (or a flash memory), an optic fiber, a portable compact disc read-only memory (CD-ROM), an optical storage device, a magnetic storage device, or any suitable combination thereof.

The foregoing descriptions are merely preferred embodiments of the present disclosure and explanations of the applied technical principles. Those skilled in the art should understand that the scope of disclosure involved in the present disclosure is not limited to the technical solutions formed by specific combinations of the foregoing technical features, and shall also cover other technical solutions formed by any combination of the foregoing technical features or equivalent features thereof without departing from the foregoing concept of disclosure. For example, a technical solution formed by a replacement of the foregoing features with technical features with similar functions disclosed in the present disclosure (but not limited thereto) also falls within the scope of the present disclosure.

In addition, although the various operations are depicted in a specific order, it should not be construed as requiring these operations to be performed in the specific order shown or in a sequential order. Under certain circumstances, multitasking and parallel processing may be advantageous. Similarly, although several specific implementation details are included in the foregoing discussions, these details should not be construed as limiting the scope of the present disclosure. Some features that are described in the context of separate embodiments can also be implemented in combination in a single embodiment. In contrast, various features described in the context of a single embodiment may alternatively be implemented in a plurality of embodiments individually or in any suitable subcombination.

Although the subject matter has been described in a language specific to structural features and/or logical actions of the method, it should be understood that the subject matter defined in the appended claims is not necessarily limited to the specific features or actions described above. In contrast, the specific features and actions described above are merely exemplary forms of implementing the claims.

I/we claim:

1. A point creation method, comprising:
displaying an area map corresponding to a target area on a display interface in response to a first trigger operation;
determining a point creation area in response to a trigger operation of a user for the area map, wherein the point creation area corresponds to at least part of the target area; and
creating a plurality of points automatically in the point creation area, and displaying the plurality of points on the area map, in response to a trigger operation for a batch creating of points.

2. The method according to claim 1, wherein after the responding to a trigger operation for the batch creating of points, the method further comprises:
displaying at least two controls on an upper layer of the display interface, wherein the at least two controls correspond to an automatic point name import control and a rule-based point name generation control; and
determining name information of the plurality of automatically created points based on a trigger operation for the at least two controls.

3. The method according to claim 2, wherein the determining name information of the plurality of automatically created points based on a trigger operation for the at least two controls comprises:
in response to the automatic point name import control being triggered, importing a target document that comprises a plurality of point names to be used, to determine the name information corresponding to the plurality of created points based on the point names to be used in the target document.

4. The method according to claim 2, wherein the determining name information of the plurality of automatically created points based on a trigger operation for the at least two controls comprises:
in response to the rule-based point name generation control being triggered, displaying a point auto-increment rule editing page; and
determining the name information of the plurality of points based on a point name generation rule in the point auto-increment rule editing page.

5. The method according to claim 2, wherein after the determining the name information of the plurality of automatically created points, the creating a plurality of points automatically in the point creation area comprises:
triggering selection of at least one point creation path in the point creation area, wherein the point creation path comprises a start point and an end point; and
configuring a point division rule for the at least one point creation path, to determine the plurality of points based on the point division rule.

6. The method according to claim 5, wherein the method further comprises:
configuring orientation information for the plurality of points, so that a robot docks based on the orientation information.

7. The method according to claim 3, wherein in the process of creating a plurality of points automatically in the point creation area, the method further comprises:
associating the name information with the plurality of automatically created points, and displaying the plurality of points and the corresponding name information on the area map.

8. The method according to claim 1, wherein the method further comprises:
displaying a plurality of editable points to be adjusted, when an operation that triggers updating of point orientation information is detected;
determining a target adjustment point based on a trigger operation for the point to be adjusted; and
editing target orientation information for the target adjustment point, to update orientation information of the target adjustment point based on the target orientation information.

9. The method according to claim 8, wherein the point to be adjusted comprises at least one of the following:
all points in the target area;
a point created in the same batch as a point to be adjusted that triggers selection; and
a point located in the same direction as the point to be adjusted that triggers selection.

10. An electronic device, comprising:
one or more processors; and
a storage apparatus configured to store one or more programs, wherein
the one or more programs, when executed by the one or more processors, cause the one or more processors to:
display an area map corresponding to a target area on a display interface in response to a first trigger operation;
determine a point location creation area in response to a trigger operation of a user for the area map, wherein the point location creation area corresponds to at least part of the target area; and
create a plurality of point locations automatically in the point location creation area, and display the plurality of point locations on the area map, in response to a trigger operation for a batch creating of point locations.

11. The electronic device according to claim 10, wherein after the responding to a trigger operation for the batch creating of point locations, the one or more programs further cause the one or more processors to:
display at least two controls on an upper layer of the display interface, wherein the at least two controls correspond to an automatic point location name import control and a rule-based point location name generation control; and
determine name information of the plurality of automatically created point locations based on a trigger operation for the at least two controls.

12. The electronic device according to claim 11, wherein the one or more programs used for the determining name information of the plurality of automatically created point locations based on a trigger operation for the at least two controls further comprises one or more programs which, when executed by the one or more processors, cause the one or more processors to:
in response to the automatic point location name import control being triggered, import a target document that comprises a plurality of point location names to be used, to determine the name information corresponding to the plurality of created point locations based on the point location names to be used in the target document.

13. The electronic device according to claim 11, wherein the one or more programs used for the determining name information of the plurality of automatically created point locations based on a trigger operation for the at least two controls further comprises one or more programs which, when executed by the one or more processors, cause the one or more processors to:
in response to the rule-based point location name generation control being triggered, display a point location auto-increment rule editing page; and
determine the name information of the plurality of point locations based on a point location name generation rule in the point location auto-increment rule editing page.

14. The electronic device according to claim 11, wherein after the determining the name information of the plurality of automatically created point locations, the one or more programs used for the creating a plurality of point locations automatically in the point location creation area further comprises one or more programs which, when executed by the one or more processors, cause the one or more processors to:
trigger selection of at least one point location creation path in the point location creation area, wherein the point location creation path comprises a start point and an end point; and
configure a point location division rule for the at least one point location creation path, to determine the plurality of point locations based on the point location division rule.

15. The electronic device according to claim 14, wherein the one or more programs further cause the one or more processors to:
configure orientation information for the plurality of point locations, so that a robot docks based on the orientation information.

16. The electronic device according to claim 12, wherein in the process of creating a plurality of point locations automatically in the point location creation area, the one or more programs further cause the one or more processors to:
associate the name information with the plurality of automatically created point locations, and display the plurality of point locations and the corresponding name information on the area map.

17. The electronic device according to claim 10, wherein the one or more programs further cause the one or more processors to:
display a plurality of editable point locations to be adjusted, when an operation that triggers updating of point location orientation information is detected;
determine a target adjustment point location based on a trigger operation for the point location to be adjusted; and
edit target orientation information for the target adjustment point location, to update orientation information of the target adjustment point location based on the target orientation information.

18. The electronic device according to claim 17, wherein the point location to be adjusted comprises at least one of the following:
all point locations in the target area;
a point location created in the same batch as a point location to be adjusted that triggers selection; and
a point location located in the same direction as the point location to be adjusted that triggers selection.

19. A non-transitory storage medium containing computer-executable instructions, wherein the computer-executable instructions, when executed by a computer processor, are used to:
display an area map corresponding to a target area on a display interface in response to a first trigger operation;
determine a point location creation area in response to a trigger operation of a user for the area map, wherein the point location creation area corresponds to at least part of the target area; and
create a plurality of point locations automatically in the point location creation area, and display the plurality of point locations on the area map, in response to a trigger operation for a batch creating of point locations.

20. The non-transitory storage medium according to claim 19, wherein the computer-executable instructions are further used to:
display a plurality of editable point locations to be adjusted, when an operation that triggers updating of point location orientation information is detected;
determine a target adjustment point location based on a trigger operation for the point location to be adjusted; and
edit target orientation information for the target adjustment point location, to update orientation information of the target adjustment point location based on the target orientation information.
